(19) United States
(12) Patent Application Publication
(10) Pub. No.: US 2023/0214226 A1
(43) Pub. Date: Jul. 6, 2023

(54) EDGE CLOUD BUILDING SYSTEM AND METHOD FOR PARALLEL INSTALLATION OF EDGE CLOUD

(71) Applicants: Jin Bum KIM, Seoul (KR); ACORNSOFT CO., LTD., Seoul (KR)

(72) Inventors: Jin Bum KIM, Seoul (KR); JI SEOK JEONG, Incheon (KR)

(21) Appl. No.: 18/147,977

(22) Filed: Dec. 29, 2022

(30) Foreign Application Priority Data
Dec. 30, 2021 (KR) 10-2021-0192221

(51) Int. Cl. G06F 9/38; G06F 9/48

(52) U.S. Cl. CPC G06F 9/3891; G06F 9/4881

(57) ABSTRACT

The present invention relates to an edge cloud infrastructure building technology, and particularly, to a system and a method for building an edge cloud, which can simultaneously a large-scale edge cloud in parallel. To this end, the edge cloud building system according to the present invention as an edge cloud building system for parallel installation of an edge cloud include, when a cloud infrastructure provisioning automation platform on a central cloud transmits a multiple cluster installation request to each of a plurality of edge clouds which is scheduled to be built, generating, by a cluster controller on the plurality of edge clouds, a custom resource (CR) based on a custom resource definition (CRD) for cluster provisioning included in the multiple cluster installation request to generate a cluster-specific worker controller; and building, by each cluster-specific worker controller, a cluster constituted by a master node and a worker node, and multiple clusters are simultaneously generated on each of the plurality of edge clouds.

### CROSS-REFERENCE TO RELATED APPLICATIONS

This application claims the priority of Korean Patent Application No. 10-2021-0192221 filed on Dec. 30, 2021, in the Korean Intellectual Property Office, the disclosure of which is incorporated herein by reference.

### BACKGROUND OF THE INVENTION

### Field of the Invention

The present invention relates to an edge cloud infrastructure building technology, and particularly, to a system and a method for building an edge cloud, which can simultaneously a large-scale edge cloud in parallel.

### Description of the Related Art

The use of a cloud infrastructure is convenient, but building the cloud infrastructure is not easy. The well-equipped cloud infrastructure as an on-demand service which is a complicated process which provides users with convenience of resource use, but in order to build the cloud infrastructure itself, a lot of time is made to prepare for commercial use from design to installation and testing (verification), and takes and involves repetition of trial and error.

The cloud infrastructure should be built by an engineer which is highly trained due to the complexity of components and the difficulty of installation and setting.

As the innovation of a computing infrastructure is spreading to edge computing through cloud computing, the intelligence of a terminal such as a robot, a drone, an autonomous vehicle, etc., progresses rapidly, so a high-level real-time response processing ability and large data collection and learning ability from the terminal are required, which cannot be compared with the conventional art by being equipped with an AI service.

Since the abilities are required, cloud computing that processes all data at the center is built, but there is a limit by the cloud computing, so an edge cloud appears in order to overcome this limit.

The demand for the edge cloud gradually increases, and the building of the edge cloud becomes a more difficult task than building the previous cloud infrastructure building.

The demand for the edge cloud significantly increases, focusing on a technology that leads the 4^{th} industrial revolution such as 5G, IoT, AI/ML, AR/VR, a robot, etc., and a difficulty in building the cloud infrastructure exponentially increases in an edge computing environment in which numerous small-unit data centers should be densely distributed throughout a broad region. In terms of Korean standards, there are more than 40000 base station-unit edge cloud infrastructures required for the 5G service.

As a result, there is a situation in which automation of building of the cloud infrastructure is required so as to meet the demand for the edge cloud.

In particular, the prior art provides installation tools for one cluster and cannot proceed with an installation task for multiple clusters in parallel. In other words, the edge cloud environment has a large number of clusters, so the installation of multiple edge clouds should be carried out at the same time with minimal intervention of the operator, and the prior art did not satisfy these requirements.

### SUMMARY OF THE INVENTION

The present invention is contrived to solve the problem, and the present invention has been made in an effort to automate building an edge cloud infrastructure to meet a demand for an edge cloud.

The present invention has also been made in an effort to allow an edge cloud operator to simultaneously build a large-scale edge cloud in parallel.

To this end, an exemplary embodiment of the present invention provides an edge cloud building system as an edge cloud building system for parallel installation of an edge cloud, which includes, when a cloud infrastructure provisioning automation platform on a central cloud transmits a multiple cluster installation request to each of a plurality of edge clouds which is scheduled to be built, generating, by a cluster controller on the plurality of edge clouds, a custom resource (CR) based on a custom resource definition (CRD) for cluster provisioning included in the multiple cluster installation request to generate a cluster-specific worker controller; and building, by each cluster-specific worker controller, a cluster constituted by a master node and a worker node, and multiple clusters are simultaneously generated on each of the plurality of edge clouds.

Here, the cluster controller receives a cluster task log from the cluster-specific worker controller and transmits the received cluster task log to the cloud infrastructure provisioning automation platform.

Meanwhile, an administrator inputs the multiple cluster installation request and inputs a real-time cluster task log by using a dashboard or a command-line interface of the cloud infrastructure provisioning automation platform.

Further, another exemplary embodiment of the present invention provides an edge cloud building method, which includes: transmitting, by a cloud infrastructure provisioning automation platform on a central cloud, a multiple cluster installation request to each of a plurality of edge clouds which is scheduled to be built; generating, by a cluster controller on the plurality of edge clouds, a custom resource (CR) based on a custom resource definition (CRD) for cluster provisioning included in the multiple cluster installation request to generate a cluster-specific worker controller; and building, by each cluster-specific worker controller, a cluster constituted by a master node and a worker node, and multiple clusters are simultaneously generated on each of the plurality of edge clouds.

Here, the method further includes receiving, by the cluster controller, a cluster task log from the cluster-specific worker controller and transmitting the received cluster task log to the cloud infrastructure provisioning automation platform.

In addition, in the building of the cluster, the cluster-specific worker controller generates the cluster by using an automation script.

According to the present invention, a plurality of edge cloud infrastructures can be simultaneously built in parallel, operation hours, it is effective to significantly reduce working hours by while repeatedly performing installation, update, backup/restoration operations for a large-scale cloud infrastructure.

### BRIEF DESCRIPTION OF THE DRAWINGS

FIG. 1 is a diagram illustrating an overall configuration of an edge cloud building system for parallel installation of an edge cloud according to the present invention.

FIG. 2 is a diagram illustrating an internal configuration of the edge cloud building system for parallel installation of an edge cloud according to the present invention.

FIG. 3 is a flowchart illustrating a parallel installation process of an edge cloud according to the present invention.

### DETAILED DESCRIPTION OF THE PREFERRED EMBODIMENT

Hereinafter, an exemplary embodiment of the present invention will be described in detail with reference to the accompanying drawings. A configuration of the present invention and the resulting operation effect will be described apparently appreciated through the following detailed description.

Prior to the detailed description of the present invention, the same component is denoted by the same reference numeral even though the same component is illustrated in another drawing, and when it is judged that a known configuration can make the gist of the present invention be ambiguous, it is noted that a detailed description will be omitted.

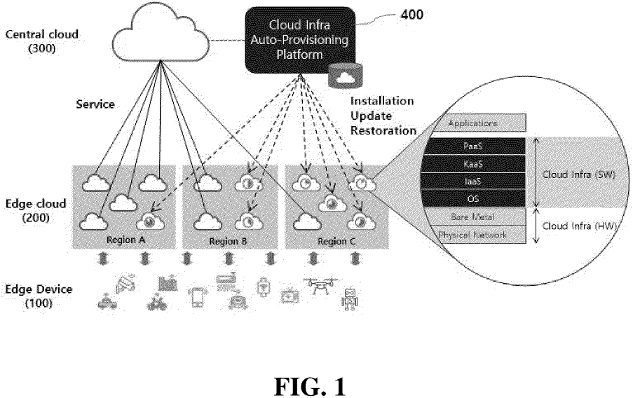

FIG. 1 is a diagram illustrating an overall configuration of an edge cloud building system for parallel installation of an edge cloud according to the present invention.

Referring to FIG. 1, the edge cloud building system is configured by an edge device 100, an edge cloud 200, a central cloud 300, and a cloud infra provisioning automation platform 400 on the central cloud 300.

The edge cloud 200 is connected to multiple edge devices 100 including an IoT sensor (not illustrated) and an actuator (not illustrated) to receive various data from the edge device 100, and perform edge computing for transmitting a control signal to the edge device 100.

The central cloud 300 receives data from multiple edge clouds 100 to execute cloud computing and deliver an execution result to the edge cloud 100.

Multiple edge devices 100 produce a lot of data (e.g., big data), and the edge cloud 200 basically performs preprocessing such as data collection from the edge device 100, data refinement for utilizing the big data, cleaning for main processing of the big data, sampling, combination, etc., and delivers the result to the central cloud 300.

A function of the edge cloud 200 may be variously designed, and for example, may also be designed to autonomously process big data without sending the big data to the central cloud 300, and also designed to perform only a basic function, and hand over all core tasks to the central cloud 300.

The central cloud 300 primarily performs deep learning, and analysis, inference, etc., related thereto, and comprehensively performs the task handed over from the edge cloud 200 or distributes some of the tasks to a specific edge cloud 200.

The result processed in the central cloud 300 or the result autonomously processed in the edge cloud 200 is applied to the edge device 100 to control an operation of the edge device 100.

The cloud infrastructure provisioning automation platform 400 (hereinafter, referred to as a provisioning automation platform) according to the present invention is provided on the central cloud 300.

The cloud infra provisioning automation platform 400 may perform tasks such as verification and backup during design, installation (new, update, and restoration), verification (before/after installation), and an operation for a plurality of edge clouds.

The provisioning automation platform 400 may perform a parallel task for a plurality of edge cloud infrastructures. That is, the automation platform 400 may perform a parallel task for a plurality of clusters within the edge cloud while simultaneously building the edge cloud by parallel arranging and operating a dedicated controller for each task target, and in this case, may perform each task without mutual influence between individual tasks.

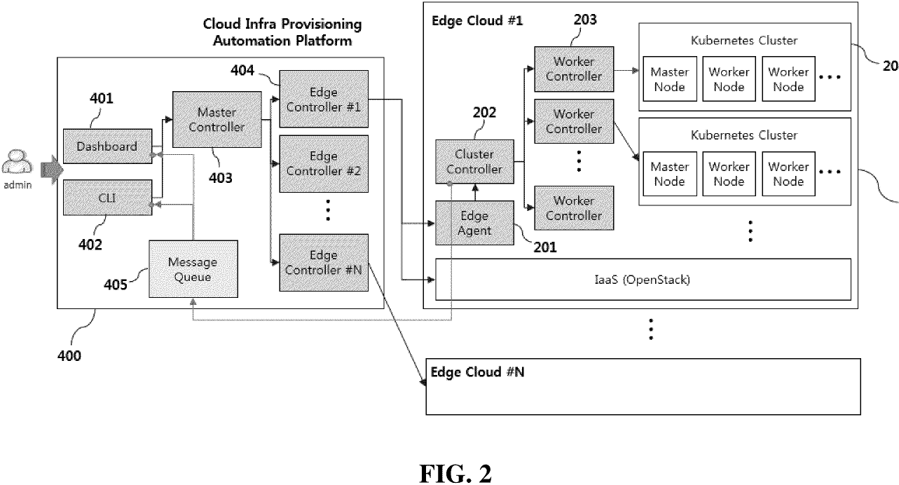

FIG. 2 illustrates an internal configuration of each subject constituting an edge cloud building system according to the present invention.

The edge cloud building system according to the present invention may be implemented by multiple edge controller and multiple cluster controller schemes in order to build the large-scale edge cloud in parallel, and cluster certification generation, cluster connection, platform component installation, etc., may be processed in one step by an automation script (Ansible script).

Referring to FIG. 2, the provisioning automation platform 400 includes a dashboard 401, a command-line interface (CLI) 402, a master controller 403, an edge cloud-specific edge controller 404, a message queue 405, etc.

An administrator may request installation of multiple clusters by using the dashboard 401 or the command line interface 402, while the administrator may identify a task state such as installation of multiple clusters, update of multiple clusters, and extension/deletion of a node.

When the master controller 403 receives a multiple cluster installation request from the administrator, the master controller 403 delivers the multiple cluster installation request to the edge controller 404 which interlocks with the edge cloud 200.

The edge controller 404 performs real-time data processing with an edge agent 201 within the edge cloud 200. The edge controller 404 may deliver a request for cluster installation and upgrade, node extension and deletion, etc., to the edge agent 201. In this case, the edge controller 404 delivers custom resource definition for cluster provisioning to the edge agent 201.

The custom resource definition (CRD) is to define a customer resource of a specific object by a user in addition to a basic workload provided in kubernetes. Equipment information (OS, system specification, CPU, a memory capacity, a disk capacity, etc.), cluster information (version, master/worker node, etc.), auto-scale information, and add-on application information are constituted by the CRD.

The edge agent 201 delivers a multiple cluster installation request and the CRD of the cluster to the cluster controller 202. The edge agent 201 performs the real-time data processing with the edge controller 404, and installs OpenStack. The edge agent 201 delivers state values related to OpenStack installation, cluster provisioning, and health check to the cluster controller 202.

The cluster controller 202 generates a customer resource (CR) based on the CRD to generate a worker controller 203 that takes charges of actual processing of the cluster.

The work controller 203 generates an instance (vm, network, load-balancer, etc.) related to the infrastructure inside the OpenStack through a cluster API, and builds the cluster with a component installer. That is, the work controller 203 may process the task such as the cluster installation and upgrade, and node extension/deletion in one step by using the automation script (Ansible script).

The work controller 203 generates a cluster task log while installing the cluster, and delivers the generated cluster task log to the edge agent 201. The edge agent 201 delivers the cluster task log to the cluster controller 202, and the cluster controller 202 transmits cluster task log information to the message queue 405 of the provisioning automation platform 400.

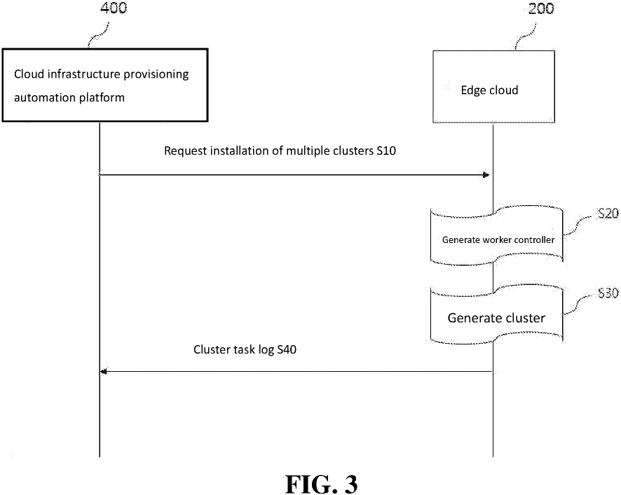

FIG. 3 illustrates a processing process for parallel installation of an edge cloud according to the present invention.

Referring to FIG. 3, first, the administrator inputs the multiple cluster installation request by using the dashboard 401 or the command-line interface 402 of the cloud infrastructure provisioning automation platform.

Then, the master controller 403 of the provisioning automation platform 400 delivers the multiple cluster installation request to the edge cloud-specific edge controller 404, and transmits the multiple cluster installation request to each of a plurality of edge clouds 200 which is scheduled to be built (S10).

The multiple cluster installation request is received by the edge agent 201 of each edge cloud 200, and the edge agent 201 delivers the multiple cluster installation request to the cluster controller 202.

Next, when each cluster controller 202 on the plurality of edge clouds 200 receives the multiple cluster installation request from the edge agent 201, the CR is generated based on the CRD for the cluster provisioning included in the multiple cluster installation request to generate the cluster-specific worker controller 203 (S20).

Thereafter, each cluster-specific worker controller 203 builds a cluster constituted by a master node and a worker node (S30). In this case, the cluster-specific worker controller 203 may generate the cluster by using the automation script. As a result, multiple clusters may be simultaneously generated on each of the plurality of edge clouds in parallel.

When multiple clusters are generated by the cluster-specific worker controller 203, the cluster task log is generated and delivered to the edge agent 201, and the edge agent 201 delivers the cluster task log to the cluster controller 202. Then, the cluster controller 202 transmits the cluster task log to the message queue 405 of the cloud infrastructure provisioning automation platform 400 (S40).

As a result, the administrator may identify the cluster task log delivered to the message queue 405 in real time by using the dashboard or the command-line interface.

The above description is just exemplarily describing the present invention, and various modifications can be made by those skilled in the art within the scope without departing from the technical spirit of the present invention. Therefore, the exemplary embodiments disclosed in the present invention do not intend to limit the present invention. The scope of the present invention should be construed based on the following claims, and all the techniques in the equivalent scope thereof should be construed as falling within the scope of the present invention.

What is claimed is:

1. An edge cloud building system for parallel installation of an edge cloud, the system comprising:
when a cloud infrastructure provisioning automation platform on a central cloud transmits a multiple cluster installation request to each of a plurality of edge clouds which is scheduled to be built,
generating, by a cluster controller on the plurality of edge clouds, a custom resource (CR) based on a custom resource definition (CRD) for cluster provisioning included in the multiple cluster installation request to generate a cluster-specific worker controller; and
building, by each cluster-specific worker controller, a cluster constituted by a master node and a worker node to simultaneously generate multiple clusters on each of the plurality of edge clouds.

2. The edge cloud building system of claim 1, wherein the cluster controller receives a cluster task log from the cluster-specific worker controller and transmits the received cluster task log to the cloud infrastructure provisioning automation platform.

3. The edge cloud building system of claim 2, wherein an administrator inputs the multiple cluster installation request and inputs a real-time cluster task log by using a dashboard or a command-line interface of the cloud infrastructure provisioning automation platform.

4. A edge cloud building method for parallel installation of an edge cloud, the method comprising:
transmitting, by a cloud infrastructure provisioning automation platform on a central cloud, a multiple cluster installation request to each of a plurality of edge clouds which is scheduled to be built;
generating, by a cluster controller on the plurality of edge clouds, a custom resource (CR) based on a custom resource definition (CRD) for cluster provisioning included in the multiple cluster installation request to generate a cluster-specific worker controller; and
building, by each cluster-specific worker controller, a cluster constituted by a master node and a worker node,
wherein multiple clusters are simultaneously generated on each of the plurality of edge clouds.

5. The edge cloud building method of claim 4, further comprising:
receiving, by the cluster controller, a cluster task log from the cluster-specific worker controller and transmitting the received cluster task log to the cloud infrastructure provisioning automation platform.

6. The edge cloud building method of claim 4, wherein in the building of the cluster, the cluster-specific worker controller generates the cluster by using an automation script.
